(19) United States
(12) Patent Application Publication
(10) Pub. No.: US 2005/0154749 A1
(43) Pub. Date: Jul. 14, 2005

(54) Method and arrangement for automated provision of service hints

(76) Inventors: Daniel D. Snow, Rochester Hills, MI (US); Stanley H. Cooke, Hartland, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/757,917

(22) Filed: Jan. 14, 2004

(51) Int. Cl. G06F 17/00

(52) U.S. Cl. 707/102

(57) ABSTRACT

A method and arrangement for assisting in correct diagnosis of a problem exhibited by a product having at least one component couples a database to various organizations within an entity responsible for design, manufacture and/or distribution of the product. An observed problem with the product is associated with a component part of the product and a description of the problem and a proposed hint for diagnosing and correcting the problem is forwarded to the database. The database then distributes the hint to a team of component specialists who may refine the hint. An approved hint file is then downloaded to parts ordering and catalog systems such that the hint is displayed whenever the component part is ordered and/or catalog inquired.

### BACKGROUND OF THE INVENTION

The invention relates generally to diagnosis and repair of multi-component products. More specifically, the invention concerns the acquisition, generation and distribution of service tips or hints.

Product suppliers, such as automotive original equipment manufacturers, constantly strive to optimize the service and repair capabilities of their dealers and service outlets. Such optimization seeks to eliminate erroneous diagnoses, and their accompanying generation of multiple customer visits for the same complaint, or over-repair which leads to excess cost.

Conventionally, diagnosis and repair at service outlets is driven by the symptom or symptoms observed by the customer and the service technician. The product supplier thus relies on the technician to access available service information related to the observed problem. If the service technician fails to access available service information, such as service bulletins generated by the products manufacturer, an improper repair or an over-repair may result.

Hence, there is a need in the prior art for an arrangement and method for generating and distributing (on an unsolicited basis) service/repair tips or hints to the service technician for avoiding incorrect diagnosis of an observed problem.

### SUMMARY OF THE INVENTION

In one aspect of the invention, a method of assisting in correct diagnosis of a problem exhibited by a product having at least one component part includes inputting to a database a description of the problem, a part identifier for the at least one component part, a description of the at least one component part itself, a product identifier, and at least one hint for assisting in diagnosing the problem. A hint file is generated in the database and associated with the at least one component part. The hint file may then be downloaded to parts ordering and catalog systems in association with the part identifier, such that whenever a request to order the at least one part is entered into the parts ordering system or an inquiry is made over the part in a parts cataloging system, the hint will be displayed.

In another aspect of the invention, an arrangement for assisting in correct diagnosis of a problem exhibited by a product having at least one component part includes a database and associated database engine adapted to communicate with a plurality of organizations within an entity responsible for distributing the at least one component part to product customers. A parts ordering system and a parts cataloging system are coupled for communication with the database and with at least one parts and service providing entity for the product. The database engine is operative to receive from at least one of the plurality of organizations a description of the problem, a part identifier for the at least one component part, a product identifier, and at least one hint for assisting in diagnosing the problem. The database engine is further operative to generate a hint file in the database, to associate it with the at least one component part and to download the hint file to the parts ordering system and to the parts cataloging system. The parts ordering system or the parts catalog system is then operative upon receiving a request from the at least one parts and service providing entity to display the hint to the at least one parts and service providing entity.

### BRIEF DESCRIPTION OF THE DRAWING

The objects and features of the invention will become apparent from a reading of a detailed description, taken in conjunction with the drawing, in which:

FIG. 1 is a block diagram of a hint generating and distribution system arranged in accordance with the principles of the invention;

FIG. 2 is a flow chart setting forth a method for service tip or hint generation and distribution in accordance with the principles of the invention; and

FIG. 3 is a example of a service repair tip for an exemplary automotive vehicle component generated in accordance with the principles of the invention.

### DETAILED DESCRIPTION

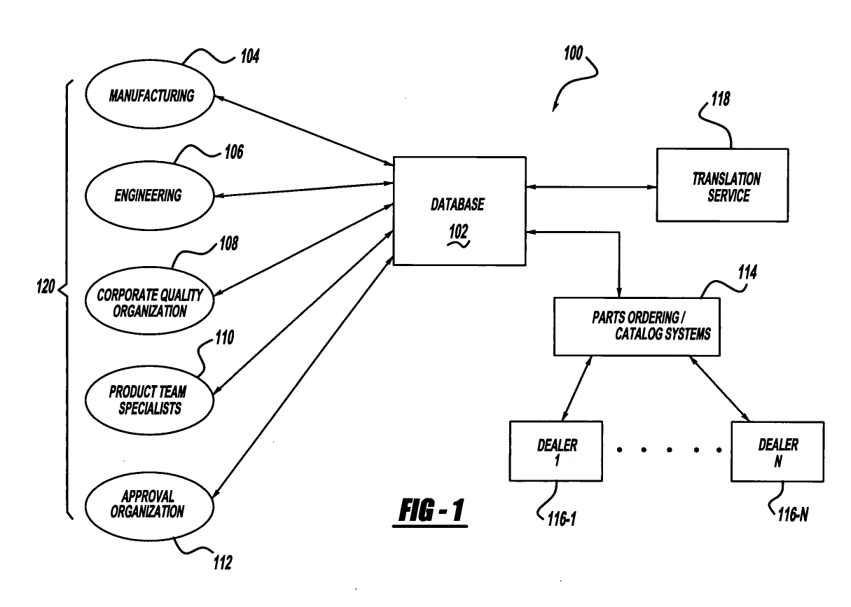

FIG. 1 sets forth a block diagram of a hint generating and distribution system arranged in accordance with the principles of the invention. A product producer 120, such as an automotive original equipment manufacturer has a number of organizations which may be involved with the generation of service or repair tips or hints. Such organizations may include manufacturing personnel 104, engineering and design personnel 106, corporate quality personnel 108, product platform team specialists 110 and approval organization 112.

Each of the organizations 104, 106, 108, 110 and 112 are coupled, for example via a personal computer intranet, to a database and associated database engine 102. One database found suitable for use with the invention is LOTUS NOTES®, commercially available from IBM Corporation.

Database 102 is additionally coupled to a computerized parts ordering system and parts catalog system 114, which, in turn, is coupled to one or more dealers 116-1 to 116-N. Database 102 may additionally be coupled to a translation service 118 for periodic conversion of the database files to languages other than English.

Repair issues for which hints or tips are to be generated are created from within the organizations of product producer 120. Database 102 is readily available to all employees within these organizations. An issue is input into the system which requires one or more service part numbers, a part description, issue description and identification of the specific product platform involved.

When the issue originator saves or files the issue, database 102 subsequently distributes this information to a prearranged list of individuals stored within database 102 which is product platform driven. Any individual on this initial distribution, or anyone who has had the issue document forwarded to their attention, can comment on the issue and add their comments to the issue file in database 102. A comment field is provided within the document generated by database 102 that captures team concerns and/or inputs. There is no alteration protection on a document at this early stage of issue generation within database 102.

After the issue document has been refined by the product team specialists 110, the approval organization 112 must review the issue. Review of issues may be done periodically, for example weekly. Refinements are made, approval is received, and the issue is moved to “load” status. Once moved to this status, the issue cannot be further modified by the organizations of entity 120. The “loaded” information is then automatically copied to computerized parts ordering system and parts catalog system 114, for example on a weekly basis. The file is also sent periodically, for example monthly, to a translation source 118 which creates preselected non-English versions of the parent file.

With the arrangement shown, the hint or tip now becomes part of a part-driven system via parts ordering system and parts catalog system 114. Whenever a service technician at one of the dealers 116 diagnoses a repair problem and believes a certain part should be ordered, the technician enters a part number request or a part inquiry into system 114. At this point, if the part number ordered or queried has an associated hint for a repair problem, that hint will be automatically displayed to the technician or part orderer. When displayed, this information must be acknowledged in order to proceed with the part ordering process. Additionally, with the arrangement of FIG. 1, the responsible parts engineer now has a method of quickly sharing information concerning the engineer's components. The engineering community often possesses unique insights as to failure modes and repair options related to components for which the organization is responsible. Database 102 allows effortless sharing of such information with the field via the arrangement shown in FIG. 1.

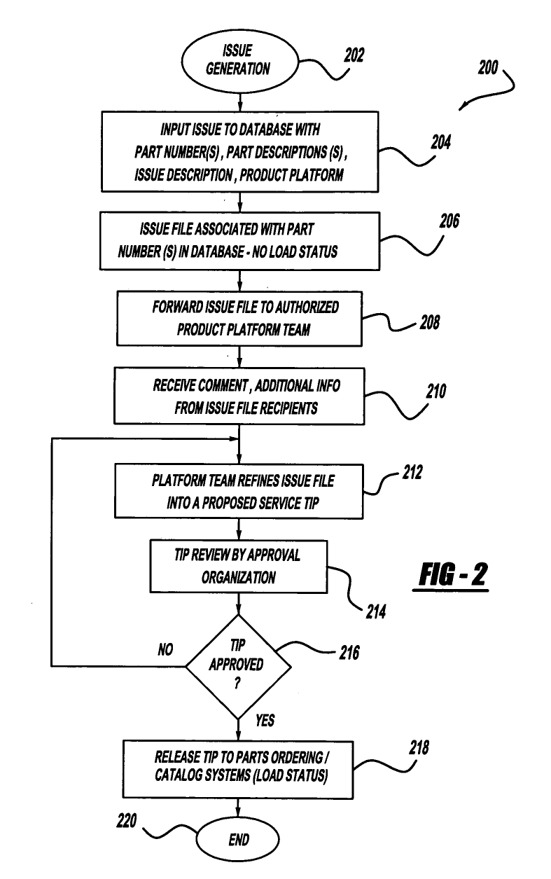

FIG. 2 sets forth a flow chart outlining the tip generation and distribution method of the invention. The method begins with issue generation at entry point 202. At 204, the issue is input to database 102 with a part number or numbers, a part description, an issue description and a product platform. At 206 the issue file is associated with a part number or numbers in database 102. This file is given a “no load” status meaning that it is not yet ready for public distribution to parts ordering system 114.

At block 208, the issue file is forwarded to members of an authorized product platform team 110. At block 210, database 102 receives comments, additional information and possible service tips or hints from the issue file recipients—mainly in product team specialists organization 110.

At block 212, the platform team refines the issue file into a proposed service tip. At block 214, the tip or hint is reviewed by the approval organization 112. At decision block 216, if the tip or hint is not approved by the approval organization 112, the method returns to block 212 for further refinement of the issue. On the other hand, if the tip does receive approval by organization 112 then the method proceeds to block 218 wherein the tip or hint is released to the parts ordering system and parts catalog 114. The hint is now ready for display to whomever orders or queries the part or parts associated with the hint and the routine ends at step 220.

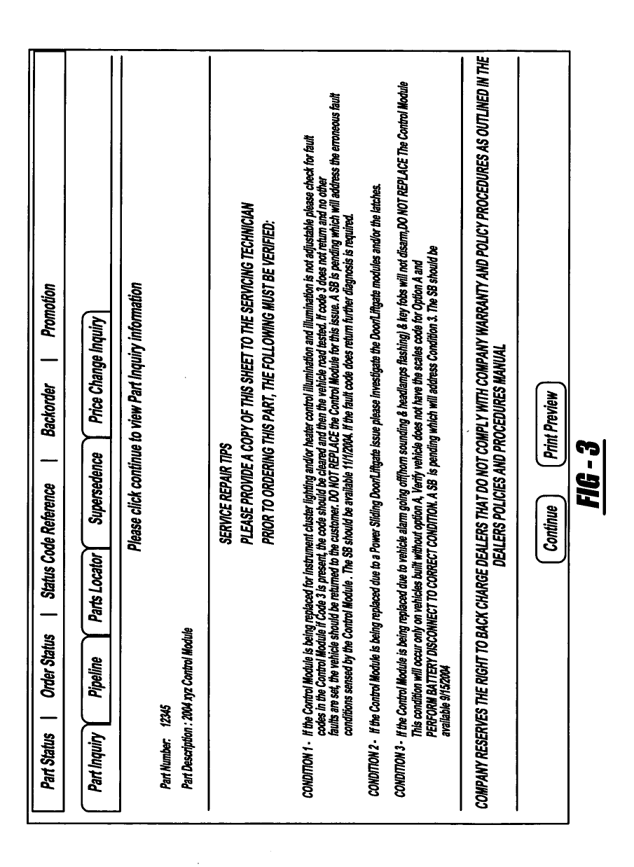

FIG. 3 sets forth an example of a repair hint generated in response to a request for ordering a part associated with the problem to be solved. This display would take place via the systems 114 at one of the dealers 116.

As seen from FIG. 3, the example repair tip concerns a control module on an automobile. Three different problem conditions are involved with the repair tips displayed. The first condition concerns illumination of an instrument cluster which is not adjustable as desired. The second condition involves a power sliding door or lift gate issue. The third condition involves a false vehicle alarm being triggered. Each of these conditions would, absent the hints set forth in FIG. 3, be assumed to require the replacement of the control module itself. As the example shows, with the service repair tips displayed, faulty or over-repair by replacement of the control module is avoided.

The invention has been described with reference to a detailed description of a preferred embodiment. The scope and spirit of the invention are to be determined from a proper interpretation of the appended claims, the exemplary description being set forth for the purposes of example only.

1. A method of assisting in correct diagnosis of a problem exhibited by a product having at least one component part, the method comprising:
inputting to a database a description of the problem, a part identifier for the at least one component part, a description of the at least one component part, a product identifier, and at least one hint for assisting in diagnosing the problem;
generating a hint file in the database and associating it with the at least one component part; and
downloading the hint file to a parts ordering system and a parts catalog system in association with the part identifier, such that whenever a request to order the at least one part is entered into the parts ordering system or an inquiry for the part is made to the parts catalog system, the hint will be displayed.

2. The method of claim 1 further comprising prior to the downloading of the hint file:
forwarding the hint file to an authorized product team; and
refining the hint file in accordance with inputs from the authorized product team.

3. The method of claim 1 further comprising prior to downloading the hint file:
forwarding the hint file to an approval organization; and
proceeding to downloading only after approval of the hint file by the approval organization.

4. The method of claim 2 further comprising after refining the hint file:
forwarding the hint file to an approval organization; and
proceeding to the downloading step only after approval of the hint file by the approval organization.

5. The method of claim 1 wherein the displayed hint alerts a viewer that the problem will not be solved by replacement of the at least one component.

6. The method of claim 6 wherein the displayed hint presents a suggested solution to the problem.

7. A method of assisting in correct diagnosis of a problem exhibited by an automotive vehicle having at least one component part, the method comprising:
inputting to a database a description of the problem, a part identifier for the at least one component part, a description of the component part, a vehicle platform identifier, and at least one hint for assisting in diagnosing the problem;
generating a hint file in the database and associating it with the at least one component part;
forwarding the hint file to an authorized vehicle platform team;
refining the hint file in accordance with input from the authorized vehicle platform team;
forwarding the refined hint file to an approval organization for review, further refinement if necessary, and approval, resulting in an approved hint file; and
downloading the approved hint file to a parts ordering system and a parts catalog system in association with the part identifier, such that whenever a request to order the at least one part is entered into the parts ordering system or an inquiry over the part is entered into the parts catalog system, the hint will be automatically displayed along with conventional part information.

8. The method of claim 7 further comprising preventing a completion of placing an order for the at least one part until a requester enters an acknowledgement to the parts ordering system acknowledging that the hint has been displayed.

9. The method of claim 7 further comprising periodically transmitting a refined hint file to a translation service operative to translate the hint into at least one other language and to send the translated hint back to the database.

10. The method of claim 7 wherein the displayed hint alerts a viewer that the problem will not be solved by replacement of the at least one component.

11. The method of claim 10 wherein the displayed hint presents a suggested solution to the problem.

12. An arrangement for assisting in correct diagnosis of a problem exhibited by a product having at least one component part, the arrangement comprising:
a database and associated database engine adapted to communicate with a plurality of organizations within an entity responsible for distributing the at least one component part to product customers;
a parts ordering system and a parts catalog system coupled for communication with the database and with at least one parts and service providing entity for the product;
wherein the database is operative to receive from at least one of the plurality of organizations a description of the problem, a part identifier for the at least one component part, a product identifier, and at least one hint for assisting in diagnosing the problem, to generate a hint file in the database, associated with the at least one component part and to download the hint file to the parts ordering system and the parts catalog system; and
wherein the parts ordering system and the parts catalog system are operative upon receiving a request or an inquiry for the at least one component from the at least one parts and service providing entity to display the hint to the at least one parts and service providing entity.

13. The arrangement of claim 12 wherein the plurality of organizations include a team of specialists for the product; and
wherein the database engine is further operative to forward the hint file to the team for refining the hint file.

14. The arrangement of claim 12 wherein the plurality of organizations includes an approval organization; and
wherein the database engine is further operative to inhibit downloading of the hint file until receipt of approval from the approval organization.

15. The arrangement of claim 12 wherein the parts ordering system is further operative to prevent completion of an order for the at least one part until receipt of a signal from the parts and service providing entity acknowledging a display of the hint.

16. The arrangement of claim 12 wherein the displayed hint alerts a viewer that the problem will not be solved by replacing the at least one component.

17. The arrangement of claim 16 wherein the displayed hint presents a suggested solution to the problem.
